(19) United States
(12) Patent Application Publication
(10) Pub. No.: US 2025/0335550 A1
(43) Pub. Date: Oct. 30, 2025

(54) MANAGING SOFTWARE UPDATES TO RADIO NODES IN A WIRELESS MOBILE NETWORK

(71) Applicant: Rakuten Symphony, Inc., Tokyo (JP)

(72) Inventor: Tasnim AHMED, Tokyo (JP)

(21) Appl. No.: 18/645,320

(22) Filed: Apr. 24, 2024

(51) Int. Cl. G06F 18/2413; G06F 8/65; G06F 18/23

(52) U.S. Cl. CPC G06F 18/24147; G06F 8/65; G06F 18/23

(57) ABSTRACT

Neighbor Nodes of a Source Node to be upgraded are sequenced by a Neighbor Node Sequencer. A first Neighbor Node sequencing method or a second Neighbor Node sequencing method is applied by the Neighbor Node Sequencer. In applying a first Neighbor Node sequencing method, Neighbor Nodes are iteratively sorted using a first formula until a calculated Gain in Collective Coverage is not greater than a predetermined Coverage Gain Threshold. A second formula is applied based on Machine Learning. In applying a second Neighbor Node sequencing method, Neighbor Nodes are sorted using the second formula based on the Machine Learning. Neighbor Nodes are sorted using a variant of the first formula.

### TECHNICAL FIELD

This description relates to managing software updates to radio nodes in a wireless mobile network.

### BACKGROUND

Cellular service providers often upgrade their network software on base stations to introduce new service features, fix software bugs, enhance quality of experience to users, or patch security vulnerabilities. Centrally controlling networks has been shown to provide value to network operators. Firmware updates are often performed periodically or based on triggers. During a firmware update, a radio node is disconnected from a network.

A software upgrade typically involves taking the network element offline or out of service. Bulk firmware updates that are performed by randomly selecting radio-nodes, e.g., Virtualized Central Units (VCUs) or Open CUs, for a given area results in catastrophic scenarios. Examples of such catastrophic scenarios include coverage blackout, a steep drop in hand-over success, etc.

Thus, service providers carefully plan the network upgrades during off-peak time to minimize the service impact. Typically, nighttime (often referred to as maintenance windows) is the time upgrades are performed due to low traffic volumes. By executing upgrades sequentially (one element after another), the spare capacity of the network is able to be maximized to offload the traffic when the network element is undergoing an upgrade. However, such sequential updates to a large network that includes thousands of radio nodes takes an excessive amount of time. Further, the ability to take into consideration the many variables involved with upgrading so many nodes is difficult.

### SUMMARY

In at least embodiment, a method includes determining to apply a first Neighbor Node sequencing method or a second Neighbor Node sequencing method. In response to determining to apply the first Neighbor Node sequencing method, Neighbor Nodes are iteratively sorted using a first formula until a calculated Gain in Collective Coverage is not greater than a predetermined Coverage Gain Threshold to produce a first Neighbor Node sequence. A second formula is applied to the first Neighbor Node sequence based on Machine Learning. A second Neighbor Node sequence is generated based on the sorting the Neighbor Nodes using the second formula based on the Machine Learning. In response to determining to apply the second Neighbor Node sequencing method, sorting the Neighbor Nodes using the second formula based on the Machine Learning to produce a third Neighbor Node sequence. The third Neighbor Nodes sequence is sorted using a third formula to generate a fourth Neighbor Node sequence.

In at least one embodiment, a Neighbor Sequencer for a Smart Scheduler is configured to determine to apply a first Neighbor Node sequencing method or a second Neighbor Node sequencing method. In response to determining to apply the first Neighbor Node sequencing method, Neighbor Nodes are iteratively sorted using a first formula until a calculated Gain in Collective Coverage is not greater than a predetermined Coverage Gain Threshold to produce a first Neighbor Node sequence. A second formula is applied to the first Neighbor Node sequence based on Machine Learning. A second Neighbor Node sequence is generated based on the sorting the Neighbor Nodes using the second formula based on the Machine Learning. In response to determining to apply the second Neighbor Node sequencing method, the Neighbor Nodes are sorted using the second formula based on the Machine Learning to produce a third Neighbor Node sequence. The third Neighbor Nodes sequence is sorted using a third formula to generate a fourth Neighbor Node sequence.

In at least one embodiment, a non-transitory computer-readable media having computer-readable instructions stored thereon, which when executed by a system cause the system to perform operations including determining to apply a first Neighbor Node sequencing method or a second Neighbor Node sequencing method. In response to determining to apply the first Neighbor Node sequencing method, Neighbor Nodes are iteratively sorted using a first formula until a calculated Gain in Collective Coverage is not greater than a predetermined Coverage Gain Threshold to produce a first Neighbor Node sequence. A second formula is applied to the first Neighbor Node sequence based on Machine Learning. A second Neighbor Node sequence is generated based on the sorting the Neighbor Nodes using the second formula based on the Machine Learning. In response to determining to apply the second Neighbor Node sequencing method, the Neighbor Nodes are sorted using the second formula based on the Machine Learning to produce a third Neighbor Node sequence. The third Neighbor Nodes sequence is sorted using a third formula to generate a fourth Neighbor Node sequence.

### BRIEF DESCRIPTION OF THE DRAWINGS

Features, aspects, and advantages of certain exemplary embodiments of the disclosure will be described below with reference to the accompanying drawings, in which like reference numerals denote like elements, and wherein:

FIG. 1 illustrates a mobile network according to at least one embodiment.

FIG. 2 is a block diagram of an Open Radio Access Network (O-RAN) according to at least one embodiment.

FIG. 3 illustrates the two methods for sequencing neighbor nodes according to at least one embodiment.

FIG. 4 is shows a method for determining a collective coverage of a Source Node by Neighbor Nodes according to at least one embodiment.

FIG. 5 is a flowchart of Formula 1 for sequencing neighbor nodes according to at least one embodiment.

FIG. 6 is a flowchart of Formula 2 for sequencing neighbor nodes using Machine Learning according to at least one embodiment.

FIG. 7 illustrates the hierarchy of the three clusters according to at least one embodiment.

FIG. 8 is a table comparing sequencing for Neighbor Nodes according to at least one embodiment.

FIG. 9 is a high-level functional block diagram of a processor-based system according to at least one embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched, as long as these modifications may not affect the resulting scope of the invention.

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]” are to be understood as including only A, only B, or both A and B.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein likewise are interpreted accordingly.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, data-streaming or signaling-streaming. The foregoing terms are utilized interchangeably in the subject specification and related drawings. The terms “access point,” “base station,” “Node B,” “evolved Node B (eNode B),” next generation Node B (gNB), enhanced gNB (en-gNB), home Node B (HNB),” “home access point (HAP),” or the like refer to a wireless network component or apparatus that serves and receives data, control, voice, video, sound, gaming, data-streaming or signaling-streaming from UE.

The foregoing disclosure provides illustration and description but is not intended to be exhaustive or to limit the implementations to the precise form disclosed. Modifications and variations are possible in light of the above disclosure or may be acquired from practice of the implementations.

Centrally controlling networks has been shown to provide value to network operators. Firmware updates are often performed periodically or based on triggers. During a firmware update, a radio node is disconnected from a network. Therefore, bulk firmware updates that are performed by randomly selecting radio-nodes, e.g., Virtualized Central Units (VCUs) or Open CUs, for a given area results in catastrophic scenarios. Examples of such catastrophic scenarios include coverage blackout, a steep drop in hand-over success, etc. Further, sequential updates to a large network that includes thousands of radio nodes takes an excessive amount of time. Also, the ability to take into consideration the many variables involved with upgrading so many nodes is difficult. Embodiments described herein implement a smart scheduler that automatically takes into consideration issues that impact network service and attempts to make a schedule of automatic software updates that are able to be executed at one time. The smart scheduler is able to keep the impact to the system and to customers significantly low or manageable.

In at least one embodiment, a method for sequencing Neighbor Nodes of a Source Node to be upgraded includes determining to apply a first Neighbor Node sequencing method or a second Neighbor Node sequencing method. In response to determining to apply the first Neighbor Node sequencing method, Neighbor Nodes are iteratively sorted using a first formula until a calculated Gain in Collective Coverage is not greater than a predetermined Coverage Gain Threshold to produce a first Neighbor Node sequence. A second formula is applied to the first Neighbor Node sequence based on Machine Learning. A second Neighbor Node sequence is generated based on the sorting the Neighbor Nodes using the second formula based on the Machine Learning. In response to determining to apply the second Neighbor Node sequencing method, the Neighbor Nodes are sorted using the second formula based on the Machine Learning to produce a third Neighbor Node sequence. The third Neighbor Nodes sequence are sorted using a third formula to generate a fourth Neighbor Node sequence.

Embodiments described herein provide a method that provides one or more advantages. For example, Neighbor Nodes compensate for a source node in response to the Source Node being offline during upgrades. Neighbors Nodes are prioritized in terms of its compensating capacity in terms of Coverage, Handover Success Rate, and Total Hand Over Attempts. A capacity-based sequence of neighbors is pre-calculated and thus is able to be used as a knowledge-base for the batch-splitting algorithm. Once a new node is added to the network, its corresponding neighbor node assessment is added to the knowledge base. A first method emphasizes Cumulative Coverage during the sequencing operation. A second method emphasizes the hierarchical features. Machine Learning is applied to sequence the Neighbor Nodes.

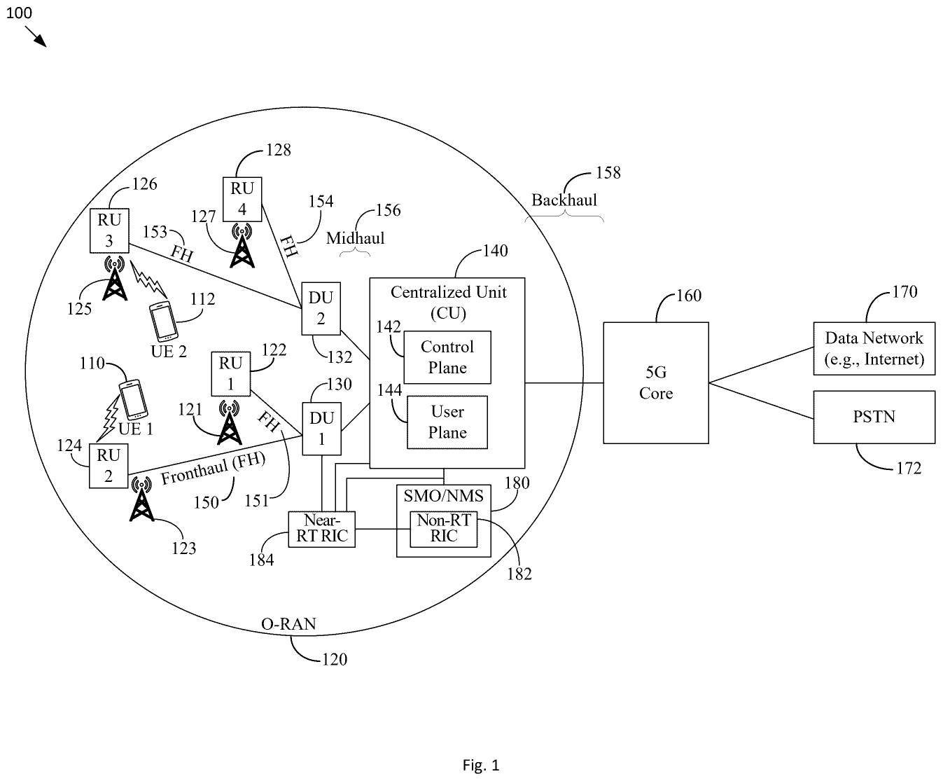

FIG. 1 illustrates a mobile network 100 according to at least one embodiment.

In FIG. 1, UE 1 (User Equipment 1) 110 and UE 2 112 access Mobile Network 100 via a Radio Access Network 120.

Radio Access Network 120 includes Radio Towers 121, 123, 125, and 127. Radio Towers 121, 123, 125, 127 are associated with RU (Radio Unit) 1 122, RU 2 124, RU 3 126, and RU 4 128, respectively.

RU 1 122, RU 2 124, RU 3 126, RU 4 128 handle the Digital Front End (DFE) and the parts of the PHY layer, as well as the digital beamforming functionality. RU 1 122 and RU 2 124 are associated with Distributed Unit (DU) 1 130, and RU 3 126 and RU 4 128 are associated with DU 2 132. DU 1 130 and DU 2 132 are responsible for real time Layer 1 and Layer 2 scheduling functions. For example, in 5G, Layer-1 is the Physical Layer, Layer-2 includes the Media Access Control (MAC), Radio link control (RLC), and Packet Data Convergence Protocol (PDCP) layers, and Layer-3 (Network Layer) is the Radio Resource Control (RRC) layer. Layer 2 is the data link or protocol layer that defines how data packets are encoded and decoded, how data is to be transferred between adjacent network nodes. Layer 3 is the network routing layer and defines how data is moves across the physical network.

DU 1 130 is coupled to the RU 1 122 and RU 2 124, and DU 2 132 is coupled to RU 3 126 and RU 4 128. DU 1 130 and DU 2 132 run the RLC, MAC, and parts of the PHY layer. DU 1 130 and DU 2 132 include a subset of the eNB/gNB functions, depending on the functional split option, and operation of DU 1 130 and DU 2 132 are controlled by Centralized Unit (CU) 140. CU 140 is responsible for non-real time, higher L2 and L3. Server and relevant software for CU 140 is able to be hosted at a site or is able to be hosted in an edge cloud (datacenter or central office) depending on transport availability and the interface for the Fronthaul connections 150, 151, 153, 154. The server and relevant software of CU 140 is also able to be co-located at DU 1 130 or DU 2 132, or is able to be hosted in a regional cloud data center.

CU 140 handles the RRC and PDCP layers. The gNB includes CU 140 and one or more DUs, e.g., DU 1 130, connected to CU 140 via Fs-C and Fs-U interfaces for a Control Plane (CP) 142 and User Plane (UP) 144, respectively. CU 140 with multiple DUs, e.g., DU 1 130, and DU 2 132, support multiple gNBs. The split architecture enables a 5G network to utilize different distribution of protocol stacks between CU 140, and DU 1 130 and DU 2 132, depending on network design and availability of the Midhaul 156. While two connections are shown between CU 140 and DU 1 130 and DU 2 132, CU 140 is able to implement additional connections to other DUs. CU 150, in 5G, is able to implement, for example, 256 endpoints or DUs. CU 140 supports the gNB functions such as transfer of user data, mobility control, RAN sharing (MORAN), positioning, session management, etc. However, one or more functions are able to be allocated to the DU. CU 140 controls the operation of DU 130 and DU 132 over the Midhaul interface 156.

Backhaul 158 connects the 4G/5G Core 160 to the CU 140. Core 160 may be, for example, up to 200 km away from the CU 140. Core 160 provides access to voice and data networks, such as Internet 170 and Public Switched Telephone Network (PSTN) 172.

RAN 120 is able to implement beamforming that allows for directional transmission or reception. 5G beamforming enables 5G connections to be more focused toward a receiving device. RAN 120 is also able to implement MIMO (Multiple Input Multiple Output), including mMIMO (massive MIMO), to provide an increases in throughput and signal-to-noise ratio (SNR). MIMO improves the radio link by using the multiple paths over which signals travel from the transmitter to the receiver. The multiple paths are de-correlated and this provides the opportunity to send multiple data streams over them.

Massive MIMO and dense small cell deployments are being implemented to improve radio resource efficiency. However, the intra-cell interference from neighboring cells presents a serious problem. According to at least one embodiment, the modeling of interference patterns in a Massive MIMO deployment is used to identify interfering beams between different sectors so that interference optimization techniques are able to be applied to address interference.

According to at least one embodiment, a northbound platform for the network is provided, such as a Service Management and Orchestration (SMO)/NMS 180. SMO 180 oversees the orchestration aspects, and the management and automation of RAN elements. SMO 180 supports O1, A1 and O2 interfaces. Non-RT RIC (non-Real-Time RAN Intelligent Controller) 182 enables non-real-time control and optimization of RAN elements and resources, AI/ML workflow including model training and updates, and policy-based guidance of applications/features in Near-RT RIC 184. Near-RT RIC 184 enables near-real-time control and optimization of O-RAN elements and resources via fine-grained data collection and actions over the E2 interface. Near-RT RIC 184 includes interpretation and enforcement of policies from Non-RT RIC 182, and supports enrichment information to optimize control function.

Near-RT RIC 184 obtains information associated with the beams that are passed to Non-RT RIC 182 and processed, for example, by an rApp at the Non-RT RIC 184, to generate an interference matrix. xApps are hosted on the Near-RT RIC 184 and are able to be used to optimize radio spectrum efficiency. rApps are specialized microservices operating on the Non-RT RIC 211. xApps and rApps provide control and management features and functionality.

AI-Based Network Management is able to be provided at the 5G Edge via the rApps in the Non-RT RIC 182. Data is collected by a Node, such as an O-CU 140. Collected Data is processed. The ML Model at the Non-RT RIC 182 is Trained/Optimized using the processed data from the database. By implementing AI-Based Network Management at the 5G EDGE, performance is adjusted through continuous learning, and failures are handled by model monitoring.

While an O-RAN 120 is shown in FIG. 1, embodiments described herein are applicable to O-RANs and Virtualized RANs (vRANs). O-RAN and vRAN disaggregate RAN hardware into three modules or functions, e.g., Radio Units (RUs) 122, 124, 126, 128, Distributed Units (DUs) 130, 132, and Centralized Units (CUs) 140. The software for these functions is decoupled from the purpose-built hardware and run on standardized, common off-the-shelf (COTS) hardware. O-RAN 120 further opens the software interfaces between radios and other network elements, whereas vRAN the interfaces between components in vRAN is still primarily based on closed or proprietary interfaces. A RAN Intelligent Controller (RIC) including Non-RT RIC 182 and RT RIC 184, is also able to be integrated with Multi-Access Edge Cloud (MEC) and vRAN. Herein, Radio Nodes refers to RUs 122, 124, 126, 128, Dus 130, 132, and CUs 140. A Smart Scheduler as described below is able to be implemented at SMO 180.

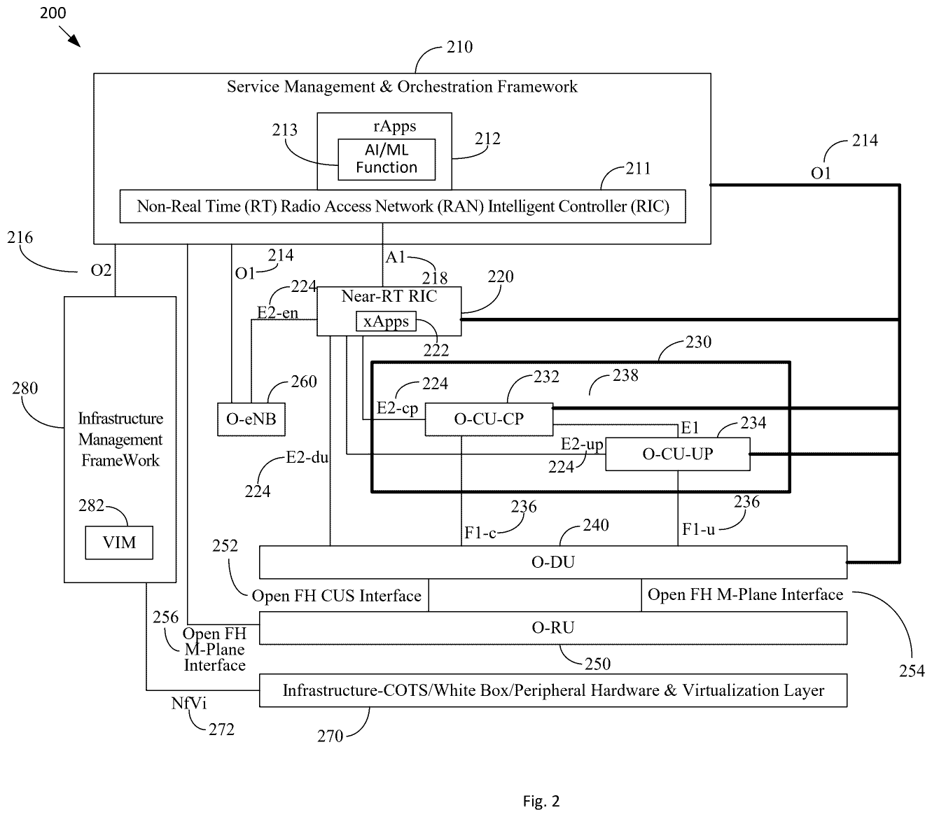

FIG. 2 is a block diagram of an Open Radio Access Network (O-RAN) 200 according to at least one embodiment.

In FIG. 2, Service Management and Orchestration (SMO) Framework 210 is an automation platform for Open RAN Radio Resources. SMO 210 oversees lifecycle management of network functions as well as O-Cloud. SMO 210 includes a Non-Real-Time (RT) Radio Access Network (RAN) Intelligent Controller (RIC) 211. SMO 210 also defines various SMO interfaces, such as the O1 214, O2 216, and A1 218 interfaces.

The A1 interface 218 enables communication between the Non-RT RIC 211 and a Near-RT RIC 220 and supports policy management, data transfer, and machine learning management. The A1 interface 218 is also used for policy guidance. SMO 210 provides fine-grained policy guidance such as getting User-Equipment to change frequency, and other data enrichments to RAN functions over the A1 interface 218.

The O1 214 interface connects the SMO 210 to the RAN managed elements, which include the Near-RT RIC 220, O-RAN Centralized Unit (O-CU) 230, O-RAN Distributed Unit (O-DU) 240, and the Open Evolved NodeB (O-eNB) 260. The management and orchestration functions are received by the managed elements via the O1 interface 214. The SMO 210 in turn receives data from the managed elements via the O1 interface 214 for A1 model training at the Non-RT RIC 211. The O1 interface 214 is further used for managing the operation and maintenance (OAM) of multi-vendor Open RAN functions including fault, configuration, accounting, performance and security management, software management, and file management capabilities.

The O2 interface 216 is used to support cloud infrastructure management and deployment operations with O-Cloud infrastructure that hosts the Open RAN functions in the network. The O2 interface 216 supports orchestration of O-Cloud infrastructure resource management (e.g., inventory, monitoring, provisioning, software management and lifecycle management) and deployment of the Open RAN network functions, providing logical services for managing the lifecycle of deployments that use cloud resources.

SMO 210 provides a common data collection platform for management of RAN data as well as mediation for the O1 214, O2 216, and A1 218 interfaces. Licensing, access control and AI/ML lifecycle management are supported by the SMO 210, together with legacy north-bound interfaces. SMO 210 also supports existing OSS functions, such as service orchestration, inventory, topology and policy control.

The Non-RT RIC 211 enables non-real-time (>1 second) control of RAN elements and their resources through cloud-native microservice-based applications, which are referred to as rApps 212. An rApp 212 is able to implement an AI/ML Function 213. Non-RT RIC 211 communicates with applications called xApps 222 running on a Near-RT RIC 211 to provide policy-based guidance for edge control of RAN elements and their resources. The Non-RT RIC 211 provides non-real-time control and optimization of RAN elements and resources, AI/ML workflow, including model training of the AI/ML Function 213, updates, and policy-based guidance of applications/features in Near-RT RIC 220.

Near-RT RIC 220 controls RAN infrastructure at the cloud edge. Near-RT RIC 220 controls RAN elements and their resources with optimization actions that typically take 10 milliseconds to one second to complete. The Near-RT RIC 220 receives policy guidance from the Non-RT RIC 211 and provides policy feedback to the Non-RT RIC 211 through the xApps 222.

The xApps 222 are used to enhance the RAN's spectrum efficiency. The Near-RT RIC 220 manages a distributed collection of “southbound” RAN functions, and also provides “northbound” interfaces for operators: the O1 214 and A1 218 interfaces to the Non-RT RIC 211 for the management and optimization of the RAN. The Near-RT RIC 220 is thus able to self-optimize across different RAN types, like macros, Massive MIMO and small cells, maximizing network resource utilization for 5G network scaling.

Within the Near-RT RIC 220, the xApps 222 communicate via defined interface channels. An internal messaging infrastructure provides the framework to handle conflict mitigation, subscription management, app lifecycle management functions, and security. Data transfers are implemented via the E2 interface.

The O-RAN is split into a Central Unit (CU) 230, a Distributed Unit (DU) 240, and a Radio Unit (RU) 250. The CU 230 is further split into two logical components, one for the Control Plane (CP) 232, and one for the User Plane (UP) 234. The logical split of the CU 230 into the CP 232 and UP 234 allows different functionalities to be deployed at different locations of the network, as well as on different hardware platforms. For example, CUs 230 and DUs 240 can be virtualized on white box servers at the edge, while the RUs 250 are implemented on Field Programmable Gate Arrays (FPGAs) and Application-specific Integrated Circuits (ASICs) boards and deployed close to RF antennas.

The O-RAN Distributed Unit (O-DU) 240 is an edge server that includes baseband processing and radio frequency (RF) functions. The O-DU 240 hosts radio link control (RLC), MAC, and a physical layer with network function virtualization or containers. O-DU 240 supports one or more cells, and the O-DUs are able to support one or more beams to provide the operating support for O-RU 250 by CUS (Control, User, and Synchronization) planes 252, and management (M) planes 254 through front-haul interfaces.

The O-RU 250 processes radio frequencies received by the physical layer of the network. The processed radio frequencies are sent to the O-DU 240 through fronthaul interfaces 252, 254. The O-RU 250 hosts the lower PHY Layer Baseband Processing and RF Front End (RF FE), and is designed to support multiple 3GPP split options.

An Open-Evolved Node B (O-eNB) 260 provides the hardware aspect of the O-RAN. The management and orchestration functions are received by the managed elements via the O1 interface 214. The SMO 210 in turn receives data from the managed elements via the O1 interface 214 for A1 model training of AI/ML Functions 213 implemented by rApps 213 at Non-RT RIC 211. The O-eNB 260 communicates with the Near-RT RIC 220 via the E2 interface 224. E2 224 enables near-real-time loops through the streaming of telemetry from the RAN and the feedback with control from the Near-RT RIC 220. The E2 interface 224 connects the Near-RT RIC 220 with an E2 node, such as the O-CU-CP 232, O-CU-UP 234, the O-DU 240, and the O-eNB 260. An E2 node is connected to one Near-RT RIC 220, while a Near-RT RIC is able to be connected to multiple E2 nodes. The protocols over the E2 interface 224 are based on the control plane and supports services and functions of Near-RT RIC 220.

An F1 Interface 236 connects the O-CU-CP 232 and the O-CU-UP 234 to the O-DU 240. Thus, the F1 interface 236 is broken into control and user plane subtypes and exchanges data about the frequency resource sharing and other network statuses. One O-CU 230 can communicate with multiple O-DUs 240 via F1 interfaces 236.

An E1 238 interface connects the O-CU-CP 232 and the O-CU-UP 234. The E1 Interface 238 is used to transfer configuration data and capacity information between the O-CU-CP 232 and the O-CU-UP 234. The configuration data ensures the O-CU-CP 232 and the O-CU-UP 234 are able to interoperate. The capacity information is sent from the O-CU-UP 234 to the O-CU-CP 232 and includes the status of the O-CU-UP 234.

The O-DU 240 communicates with the O-RU 250 via an Open Fronthaul (FH) Control, User, and Synchronization (CUS) Plane Interface 252 and an M-Plane (Management Plane) Interface 254. As part of the CUS Plane Interface 252, the C-Plane (control plane) is a frame format that carries data in real-time control messages between the O-DU 240 and O-RU 250 for use to control user data scheduling, beamforming weight selection, numerology selection, etc. Control messages are sent separately for downlink (DL)-related commands and uplink (UL)-related commands.

The U-Plane carries the user data messages between the O-DU 240 and O-RU 250, such as the in-phase and quadrature-phase (IQ) sample sequence of the orthogonal frequency division multiplexing (OFDM) signal. The S-plane includes synchronization messages used for timing synchronization between O-DU 240 and O-RU 250. The Control and User Plane are also used to send information specifying beamforming weights from the O-DU 240 to O-RU 250. Other information includes time resource and frequency resource information.

The M-Plane 254 connects the O-RU 250 to the O-DU 240, and an optional M-Plane 256 connects the O-RU 250 to the SMO 210. The O-DU 240 uses the M-Plane 254 to manage the O-RU 250, while the SMO 210 is able to provide FCAPS (Fault, Configuration, Accounting, Performance, Security) services to the O-RU 250. The M-plane 254 supports the management features including startup installation, software management, configuration management, performance management, fault management and file management.

The M-Plane 254 is used by the O-DU 240 to retrieve the capabilities of the O-RU 250 and to send relevant configuration related to the C-Plane and U-Plane (data plane) to the O-RU 250. Together the O1 214 and Open-Fronthaul M-plane 254 interfaces provide a FCAPS interface with configuration, reconfiguration, registration, security, performance, monitoring aspects exchange with individual nodes, such as O-CU-CP 232, O-CU-UP 234, O-DU 240, and O-RU 250, as well as Non-RT RIC 220.

Infrastructure-COTS/White Box/Peripheral Hardware & Virtualization Layer 270 connects to Infrastructure Management Framework 280 via Network Function Virtualization Interface (NFVI) 272. Virtualized Infrastructure Manager (VIM) 282 at Infrastructure Management Framework 280 controls and manages virtual network functions.

According to at least one embodiment, a Smart Scheduler 282 is able to be implemented at SMO 210. Smart Scheduler 282 prepares for automatic bulk/batchwise radio-node software/firmware updates and other maintenance activities. Smart Scheduler 282 provides automatic bulk/batchwise scheduling of software upgrade for radio nodes. Smart Scheduler 282 automatically takes into consideration issues that impact network service and attempts to make a schedule of automatic software updates that are able to be executed at one time. Smart Scheduler 282 is able to keep the impact to the system and to customers significantly low or manageable.

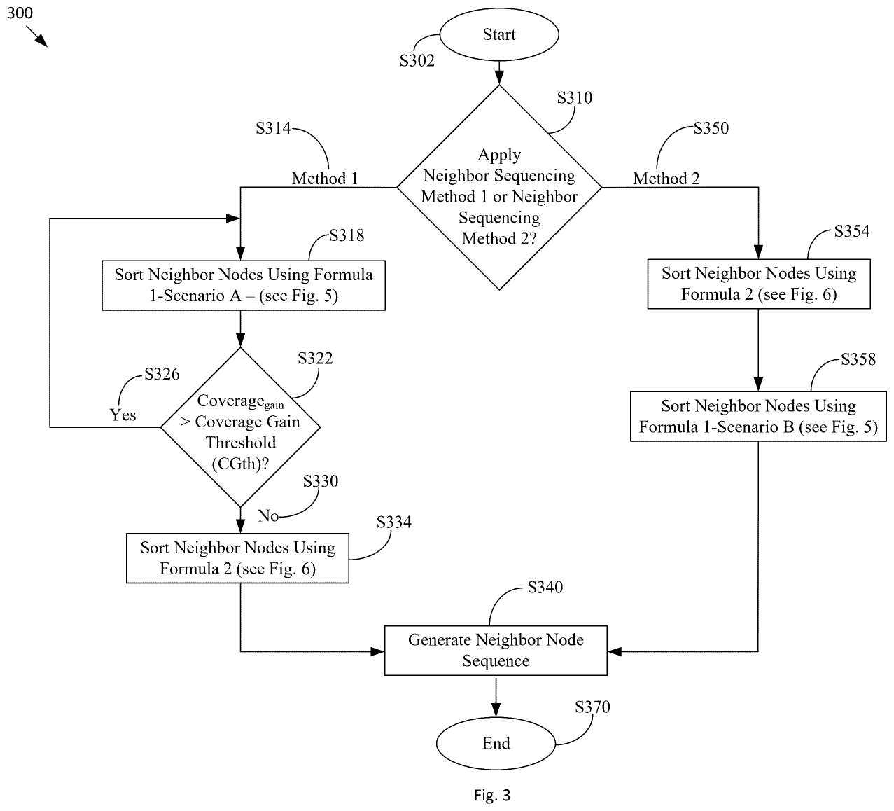

FIG. 3 is a flowchart of the two methods for sequencing neighbor nodes 300 according to at least one embodiment.

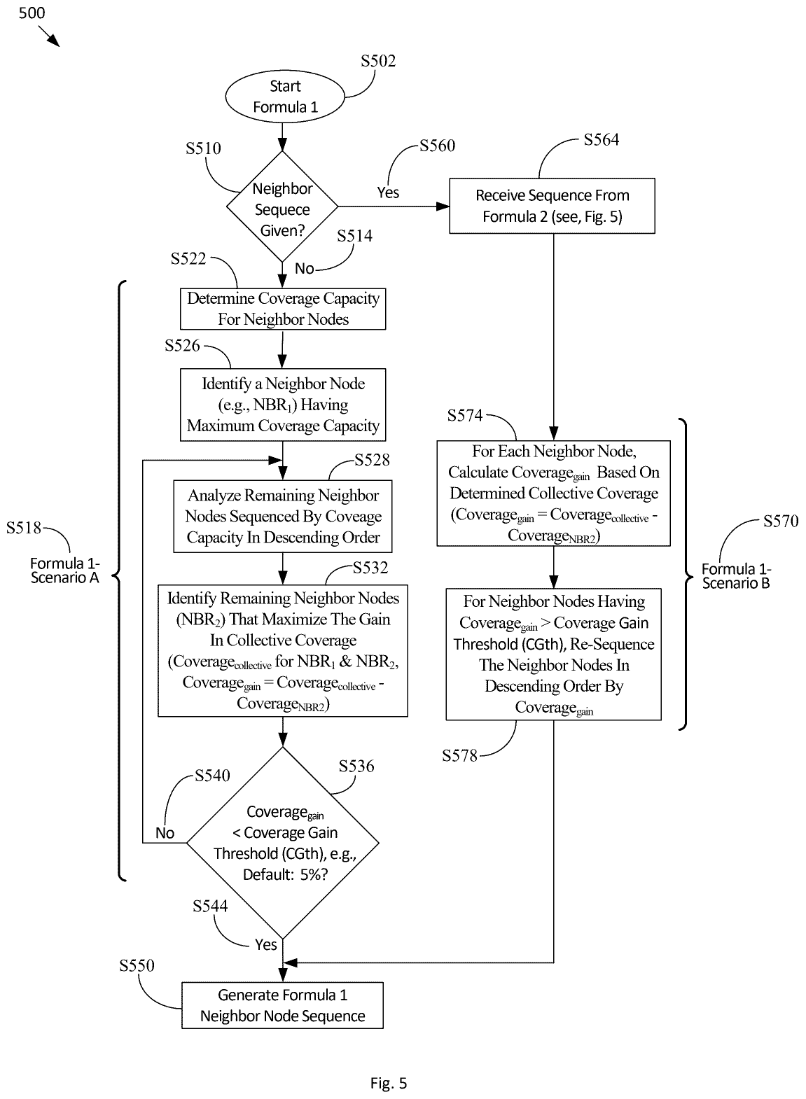

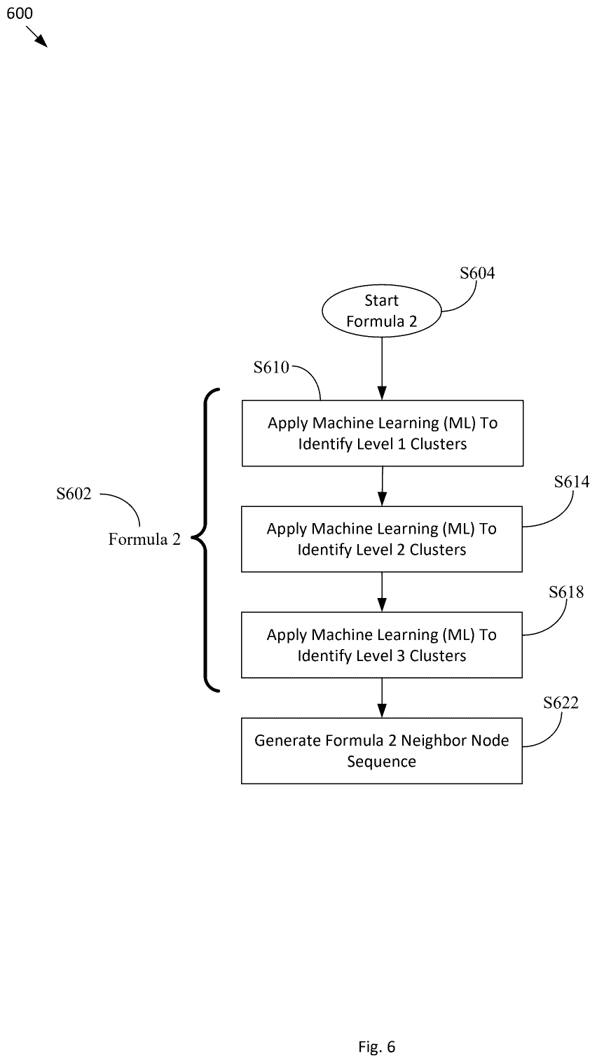

In FIG. 3, the process starts S302 and a decision S310 is made whether to apply Method 1 or Method 2 for sequencing neighbor nodes. In Method 1 S314, Neighbors are first sequenced using Formula 1-Scenario A S318 (see FIG. 5), where a Neighbor Sequence (from Formula 2, see FIG. 6) is not given. Neighbor Nodes are sequenced using Formula 1-Scenario A as described below with reference to FIG. 5. A decision is made whether the Coverage_{gain} is greater than the Coverage Gain Threshold (CGth) S322.

In response to the Coverage_{gain} being greater than the Coverage Gain Threshold (CGth) S326, the process loops back to step S318 to consider other Neighbor Nodes for sequencing iteratively using Formula 1-Scenario A. The process loops through the Neighbor Nodes iteratively to determine the Neighbor Nodes that has the highest collective gain. The first Neighbor Nodes are the most important and the first Neighbor Nodes are thus used to determine which Neighbor Nodes maximize the coverage gain. However, in response to the gain starting to decrease, then looping through the remaining Neighbor Nodes does not provide a benefit. Instead, Machine Learning is applied to sort the remaining Neighbor Nodes. Thus, in response to the Coverage_{gain} not being greater than the Coverage Gain Threshold (CGth) S330, Neighbor Nodes are sorted using Formula 2 (Machine Learning) S334. Formula 2 is described in more detail with respect to FIG. 6. A Neighbor Node Sequence is then generated S340.

In response Method 2 being used S350, Neighbor Nodes are first sorted using Machine Learning of Formula 2 S354 (see FIG. 6). Then, Formula 1-Scenario B S358 (see FIG. 5) is applied, i.e., a Neighbor Node-sequence is given from the Machine Learning of Formula 2 (see FIG. 6). Formula 1-Scenario B is applied to calculate the collective coverage for a Neighbor Node and then re-sequence the Neighbor Nodes based on the gain in collective coverage. After applying Formula 1-Scenario B S358, a Neighbor Node sequence is generated S340. The process then ends S370.

Method 1 S314 applies Formula 1-Scenario A S318 at first for selecting the top Neighbor Nodes, whereas Method 2 S350 applies Formula 1-Scenario B S358 last for selecting the top Neighbor Nodes.

Method 1 S314 is more time consuming because of the process of looping iteratively through the Neighbor Nodes using Formula 1-Scenario A S318.

In addition to Method 1 S314 being more time consuming, Method 1 S314 is more expensive computationally. Method 2 S350 is much faster than Method 1 S314 because there is no looping process involved and is less expensive computationally. However, statistically there is about a 5% deviation overall between the Method 1 S314 and Method 2 S350. In Method 1 S314 and Method 2 S350, the two formulas, Formula 1-Scenario A/Scenario B S318/S358 and Formula 2 S334, S354 are able to be combined to create a neighbor sequencing operation.

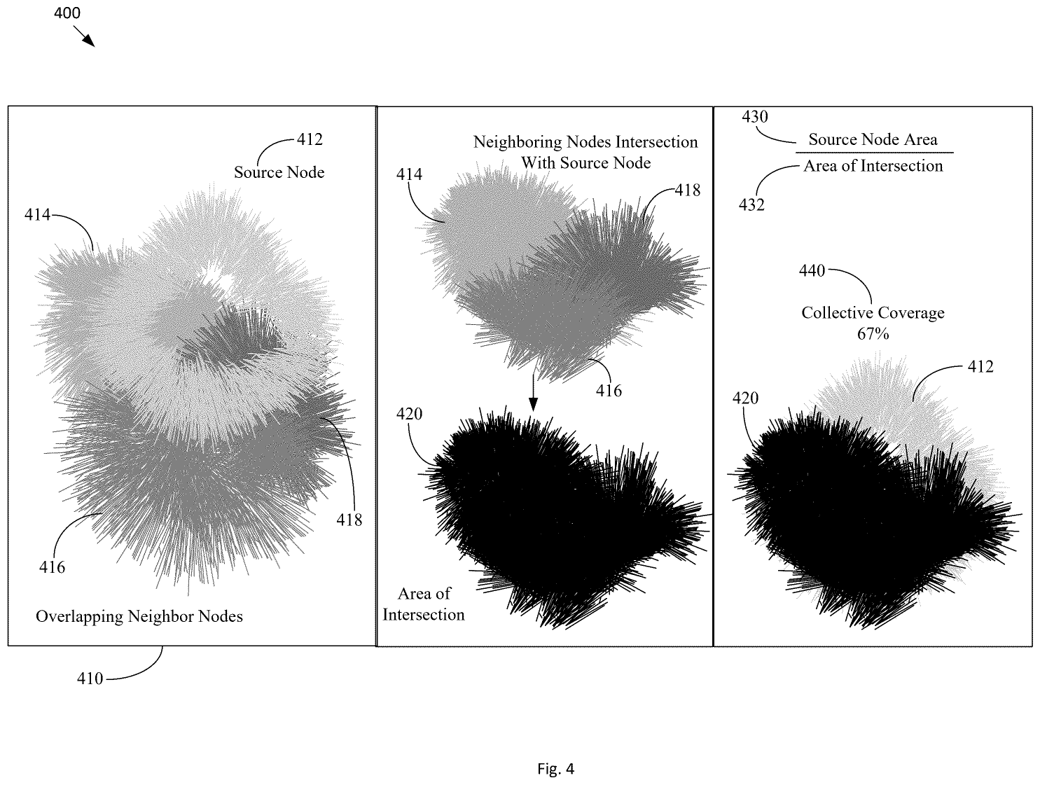

FIG. 4 is shows a method 400 for determining a collective coverage of a Source Node by Neighbor Nodes according to at least one embodiment.

In FIG. 4, a map 410 of coverage of a Source Node 412 and 3 Neighbor Nodes 414, 416, 418 are shown. Source Node 412 is a node on which the operation of software update and maintenance are executed. Source Nodes 412 is a node that is being planned to shut down for maintenance or software update. Neighbor Nodes 414, 416, 418 are nodes that are close to a Source Node 412 and that are to be used for compensating in terms of coverage or handover for Source Node 412 when the Source Node 412 is offline due to maintenance or software update. Those skilled in the art recognize that a greater number or a lesser number of Neighbor Nodes 414, 416, 418 than 3 are able to be involved.

Compensation capacity based sequence of Neighbor Nodes 414, 416, 418 is able to be pre calculated for use as knowledge-base for the batch splitting operation. Once a new Source Node 412 is added to the network, its corresponding neighbor node assessment will be added to the knowledge base. This can be treated as an isolated task that does not affect the batch-splitting pipeline, which will use the latest knowledge-base. First, Neighbor Nodes 414, 416, 418 are prioritized in terms of compensation capacity, which means Coverage, Handover, Handover Success and Total Handover Attempts. Handover Attempts are the number of times a call has been forwarded from a Source Node 412 to one of Neighbor Nodes 414, 416, 418 and the Handover Success Rate is a measure of how many times one of Neighbor Nodes 414, 416, 418 has successfully received those forwarded calls.

From the Neighbor Nodes 414, 416, 418, an Area of Intersection 420 of the Neighbor Nodes 414, 416, 418 is determined. Then, the Area of Intersection 420 is compared to the coverage of the Source Node 412 to determine a Collective Coverage 440. Collective Coverage is the ratio of Source Node Area 430 to the Area of Intersection 432,

$$\frac{Source Node Area}{Area of Intersection} .$$

In FIG. 4, Collective Coverage 440 is estimated to be 67%.

FIG. 5 is a flowchart 500 of Formula 1 for sequencing neighbor nodes according to at least one embodiment.

In FIG. 5, Formula 1 includes Formula 1-Scenario A S518 where a Neighbor Sequence (from Formula 2 as described below) is not given and Formula 1-Scenario B S570 where a Neighbor Sequence (from Formula 2 as described below) is given. The process begins S502 and a decision is made whether a Neighbor Sequence is given S510. Neighbor Sequence is provided for Formula 1-Scenario B S570 but not Formula 1-Scenario A S518

In response to a Neighbor Sequence not being given S514, Coverage Capacity is determined for Neighboring Nodes as explained above with respect to FIG. 4 S522. Formula 1-Scenario A S518 identifies a Neighbor Node having a maximum coverage capacity S526. As described above with reference to FIG. 4, Coverage Capacity is estimated using geo mapping. The remaining Neighbor Nodes are analyzed according to Coverage Capacity in descending order S528. Remaining Neighbor Nodes are identified that maximize the Gain in Collective Coverage S532, e.g., Collective_{coverage} for NBR₁, NBR₂, etc. A Neighbor Node having the most gain in the collective coverage is added, and the process loops through the remaining neighbor nodes iteratively until the neighbor nodes have been considered. Coverage Gain is given by:

$${Coverage}_{gain} = {Coverage}_{collective} - {Coverage}_{{NBR}_{2}} .$$

A decision is made whether the Coverage_{gain} is less than the Coverage Gain Threshold (CGth) S536. In response to the Coverage_{gain} not being less than the Coverage Gain Threshold (CGth) S540, the process loops back to step S528 to consider other Neighbor Nodes iteratively. In response to the Coverage_{gain} being less than the Coverage Gain Threshold (CGth) S544, the sequencing in Formula 1-Scenario A stops and a Formula 1 Neighbor Node Sequence is generated S550. As will be shown below, the Formula 1-Scenario A is provided to a second formula, i.e., Formula 2.

In response to a Neighbor Sequence being given (from Formula 2) S560, the Neighbor Sequence is received from Formula 2 S564. For Formula 1-Scenario B S570, the Coverage_{gain} is calculated for a Neighbor Node in the given sequence S574. For Neighbor Nodes having a Coverage_{gain} that is greater than the Coverage Gain Threshold (CGth), these Neighbor Nodes are re-sequenced in descending order by Coverage_{gain} S578. Formula 1-Scenario B S570 then stops and a Neighbor Node Sequence is generated S550.

FIG. 6 is a flowchart 600 of Formula 2 for sequencing neighbor nodes using Machine Learning according to at least one embodiment.

In FIG. 6, Formula 2 S602 is based on Machine Learning. In FIG. 6, the process for Formula 2 starts S604 and Machine Learning is applied to cluster Neighbor Nodes. For example, in at least one embodiment, Machine Learning uses an agglomerative hierarchical clustering algorithm. Neighbor Node sequencing is performed considering 3 performance Parameters with hierarchically descending priority sequence as: 1. Coverage, 2. Handover Success Rate, and 3. Handover Attempt Count. Neighbor Nodes are clustered based on the first priority parameter, e.g., Coverage is the highest priority, second is Handover Success Rate, and next is Handover Attempts. Thus, a hierarchy of priorities for the parameters is used. The neighbors which are having very close coverage performance are clustered. In these clusters, the nodes are re-clustered again based on Handover Success Rate. Inside the second level clusters, the neighbors are sequenced by handover attempts.

As shown in FIG. 6, Machine Learning is applied to identify Level 1 Clusters S610. Level 1 Clusters are Neighbor Nodes that are clustered based on a similarity in coverage compensation. In at least one embodiment, the Machine Learning is Agglomerative Hierarchical Clustering that groups Neighbor Nodes together that have a significantly low variance range. Accordingly, Neighbor Nodes that are clustered under the same cluster are inseparable due to similarity in coverage compensation scale.

Machine Learning is applied to identify Level 2 Clusters S614. Inside Level 1 cluster are Level 2 Clusters that are micro-clusters. Level 2 Clusters are clustered based on Handover Success Rate. The Level 1 Clusters and the Level 2 Microclusters inside the Level 1 Clusters are sequenced using a corresponding average in parameter values, e.g., Coverage and Handover Success-Rate for Level 1 Clusters and Level 2 Microclusters, respectively.

Machine Learning is applied to identify Level 3 Clusters S618. Level 3 Clusters are the Neighbor Nodes inside the Level 2 Microclusters that are sequenced based on the Total Handover Attempts with the Source Node.

Thus, after 3 steps, Neighbors Nodes are sequenced and a Formula 3 Neighbor Node sequence is generated S622.

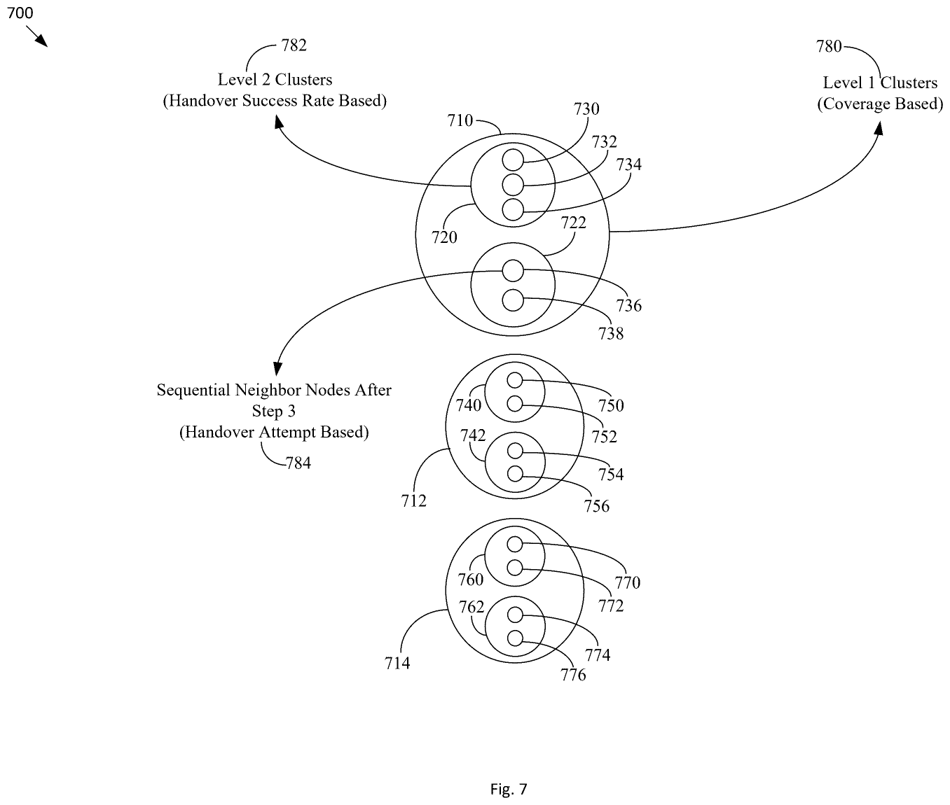

FIG. 7 illustrates the hierarchy of the three clusters 700 according to at least one embodiment.

In FIG. 7, Level 1 Clusters 710, 712, 714 are shown, which are clustered based on Coverage. Level 2 Clusters 720, 722 are shown inside Level 1 Cluster 710. Level 2 Clusters 740, 742 are shown inside Level 1 Cluster 712. Level 2 Clusters 760, 762 are shown inside Level 1 Cluster 714. Level 2 Clusters are clustered based on Handover Success Rate.

Next, Level 3 Clusters are shown inside Level 2 Clusters. Level 3 Clusters 730, 732, 734 are shown inside Level 2 Cluster 720. Level 3 Clusters 736, 738 are shown inside Level 2 Cluster 722. Level 3 Clusters 750, 752 are shown inside Level 2 Cluster 740. Level 3 Clusters 754, 756 are shown inside Level 2 Cluster 742. Level 3 Clusters 770, 772 are shown inside Level 2 Cluster 760. Level 3 Clusters 774, 776 are shown inside Level 2 Cluster 762. Level 3 Clusters are based on Handover Attempts.

As shown, Level 1 Clusters 780 are based on Coverage. Level 2 Clusters 782 are based on Handover Success Rate. Level 3 Clusters 784 are based on Handover Success Rate.

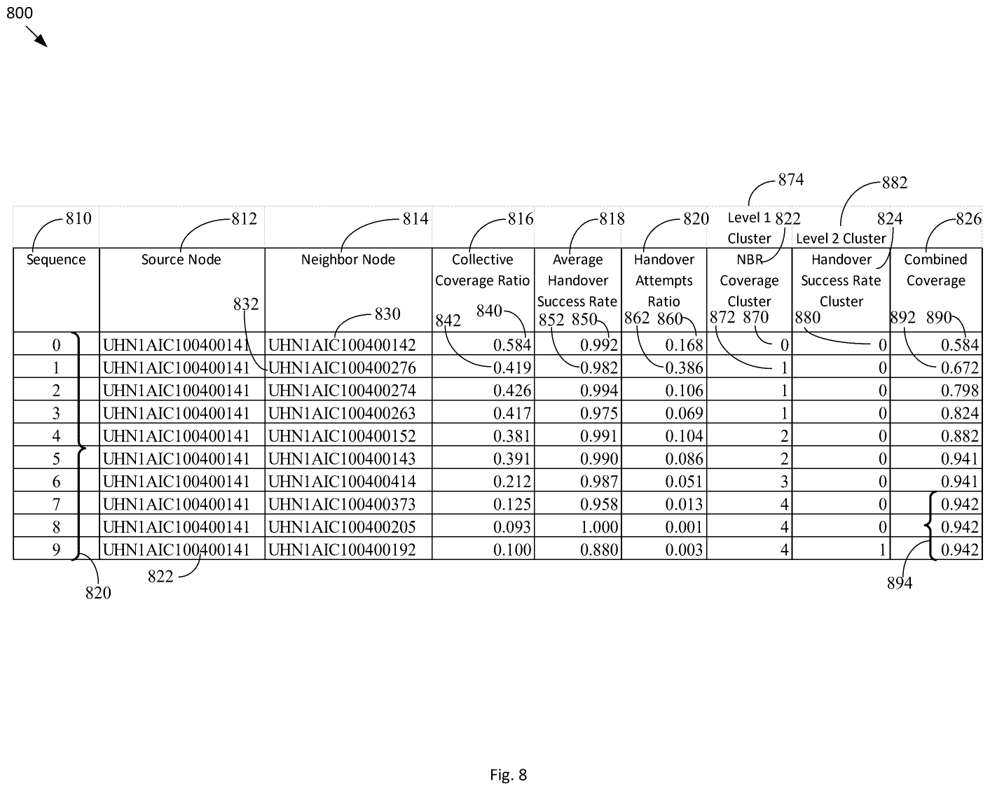

FIG. 8 is a Table 800 comparing sequencing for Neighbor Nodes according to at least one embodiment.

In FIG. 8, Table 800 includes columns for Sequences 810, Source Node 812, Neighbor Node 814, Collective Coverage Ratio 816, Average Handover Success Rate 818, Handover Attempts Ratio 820, NBR Coverage Cluster 822, Handover Success Rate Cluster 824, and Combined Coverage 826.

Sequences 810 are identified by a Sequence Number 820. The same Source Node Identifier 822 is shown for all 10 sequences 820. Neighbor Node Identifier 830 of UHN1A1C100400142 is shown for Sequence 0. Neighbor Node Identifier 832 of UHN1A1C100400276 is shown for Sequence 1. Sequence 0 has a Collective Coverage Ration 816 of 0.584 840. Sequence 1 has a Collective Coverage Ration 816 of 0.419 842.

Sequence 0 has an Average Handover Success Rate 818 of 0.992 860. Sequence 1 has an Average Handover Success Rate 818 of 0.982 862. Sequence 0 has a Neighbor (NBR) Coverage Cluster of 0 870. Sequence 1 has a Neighbor (NBR) Coverage Cluster of 1 871. Sequence 0 has a Handover Success Rate Cluster of 0 880. All but Sequence 9 have Handover Success Rate Cluster of 0 880. Sequence 0 has a Combined Collective Coverage 826 of 0.584 890. Sequence 1 has a Combined Collective Coverage 826 of 0.672 892.

Level 1 Clusters 874 and Level 2 Clusters 882 are shown for the 10 sequences. The sequences are sorted according to Combined Coverage 826.

As can be seen, there are five level 1 clusters, 0-4, which are clustered by Coverage. Level 2 Clusters 882 are then clustered by Handover Success Rate. Combined Coverage 826 is shown to have increased significantly while additional neighbors are added. However, the gain begins to reach a limit as additional neighbors are added, and the gain levels out for the last three neighbors 894 have stopped increasing (stopped at 0.942).

At least one embodiment of the method for sequencing Neighbor Nodes of a Source Node to be upgraded includes determining to apply a first Neighbor Node sequencing method or a second Neighbor Node sequencing method. In response to determining to apply the first Neighbor Node sequencing method, Neighbor Nodes are iteratively sorted using a first formula until a calculated Gain in Collective Coverage is not greater than a predetermined Coverage Gain Threshold to produce a first Neighbor Node sequence. A second formula is applied to the first Neighbor Node sequence based on Machine Learning. A second Neighbor Node sequence is generated based on the sorting the Neighbor Nodes using the second formula based on the Machine Learning. In response to determining to apply the second Neighbor Node sequencing method, the Neighbor Nodes are sorted using the second formula based on the Machine Learning to produce a third Neighbor Node sequence. The third Neighbor Nodes sequence is sorted using a third formula to generate a fourth Neighbor Node sequence.

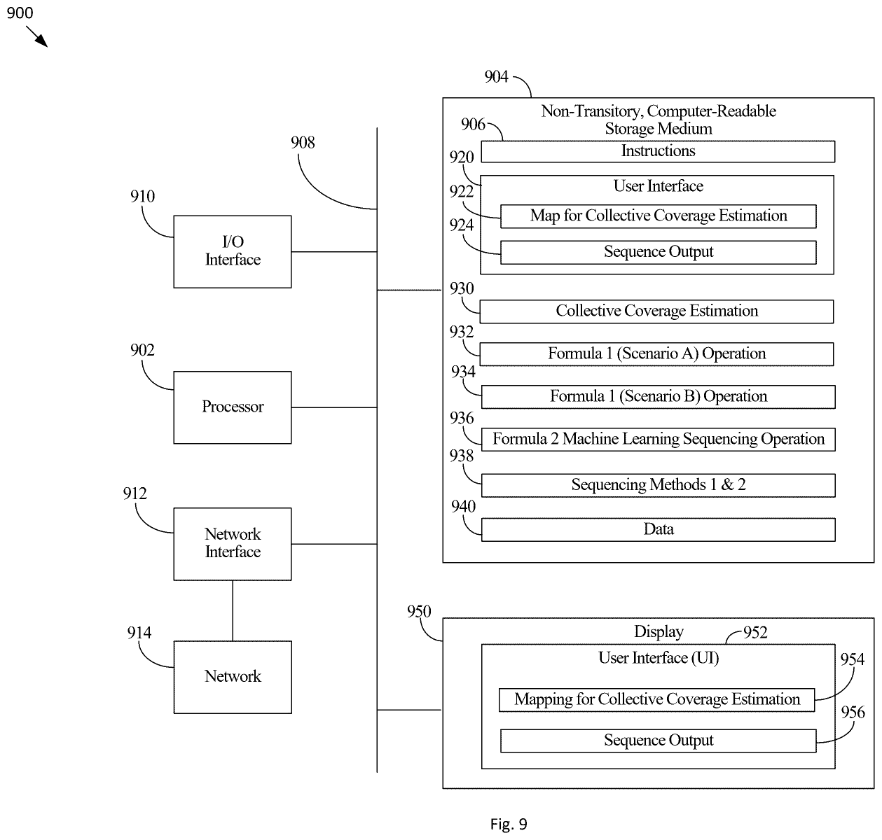

FIG. 9 is a high-level functional block diagram of a processor-based system 900 according to at least one embodiment.

In at least one embodiment, processing circuitry 900 provides smart scheduling to manage software updates to radio nodes in a wireless mobile network. Processing circuitry 900 implements a smart scheduler 930 to manage software updates to radio nodes in a wireless mobile network using Processor 902. Processing circuitry 900 also includes a Non-Transitory, Computer-Readable Storage Medium 904 that is used to implement smart scheduling to manage software updates to radio nodes in a wireless mobile network. Non-Transitory, Computer-Readable Storage Medium 904, amongst other things, is encoded with, i.e., stores, Instructions 906, i.e., computer program code, that are executed by Processor 902 causes Processor 902 to perform operations for providing smart scheduling to manage software updates to radio nodes in a wireless mobile network. Execution of Instructions 906 by Processor 902 represents (at least in part) an application which implements at least a portion of the methods described herein in accordance with one or more embodiments (hereinafter, the noted processes and/or methods).

Processor 902 is electrically coupled to Non-Transitory, Computer-Readable Storage Medium 904 via a Bus 908. Processor 902 is electrically coupled to an Input/Output (I/O) Interface 910 by Bus 908. A Network Interface 912 is also electrically connected to Processor 902 via Bus 908. Network Interface 912 is connected to a Network 914, so that Processor 902 and Non-Transitory, Computer-Readable Storage Medium 904 connect to external elements via Network 914. Processor 902 is configured to execute Instructions 906 encoded in Non-Transitory, Computer-Readable Storage Medium 904 to cause processing circuitry 900 to be usable for performing at least a portion of the processes and/or methods. In one or more embodiments, Processor 902 is a Central Processing Unit (CPU), a multi-processor, a distributed processing system, an Application Specific Integrated Circuit (ASIC), and/or a suitable processing unit.

Processing circuitry 900 includes I/O Interface 910. I/O interface 910 is coupled to external circuitry. In one or more embodiments, I/O Interface 910 includes a keyboard, keypad, mouse, trackball, trackpad, touchscreen, and/or cursor direction keys for communicating information and commands to Processor 902.

Processing circuitry 900 also includes Network Interface 912 coupled to Processor 902. Network Interface 912 allows processing circuitry 900 to communicate with Network 914, to which one or more other computer systems are connected. Network Interface 912 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 900 is configured to receive information through I/O Interface 910. The information received through I/O Interface 910 includes one or more of instructions, data, design rules, libraries of cells, and/or other parameters for processing by Processor 902. The information is transferred to Processor 902 via Bus 908. Processing circuitry 900 is configured to receive information related to a User Interface (UI) through I/O Interface 910. The information is stored in Non-Transitory, Computer-Readable Storage Medium 904 as UI 920.

In one or more embodiments, one or more Non-Transitory, Computer-Readable Storage Medium 904 having stored thereon Instructions 906 (in compressed or uncompressed form) that may be used to program a computer, processor, or other electronic device) to perform processes or methods described herein. The one or more Non-Transitory, Computer-Readable Storage Medium 904 includes one or more of an electronic storage medium, a magnetic storage medium, an optical storage medium, a quantum storage medium, or the like.

For example, the Non-Transitory, Computer-Readable Storage Medium 904 may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more Non-Transitory Computer-Readable Storage Media 904 includes a Compact Disk-Read Only Memory (CD-ROM), a Compact Disk-Read/Write (CD-R/W), and/or a Digital Video Disc (DVD).

In one or more embodiments, Non-Transitory, Computer-Readable Storage Medium 904 stores Instructions 906 configured to cause Processor 902 to perform at least a portion of the processes and/or methods for providing smart scheduling to manage software updates to radio nodes in a wireless mobile network. In one or more embodiments, Non-Transitory, Computer-Readable Storage Medium 904 also stores information, such as algorithm which facilitates performing at least a portion of the processes and/or methods for providing smart scheduling to manage software updates to radio nodes in a wireless mobile network.

Accordingly, in at least one embodiment, Processor 902 executes Instructions 906 stored on the one or more Non-Transitory, Computer-Readable Storage Medium 904 to implement neighbor sequencer for a smart scheduler for managing software updates to radio nodes in a wireless mobile network. Processor 902 implements a Map for Collective Coverage Estimation 922 and Sequence Output 924. Gain in Collective Coverage is able to be used to sequence Neighbor Nodes. Processor 902 determines Collective Coverage Estimation 930 based on Map for Collective Coverage Estimation 922. Processor 902 stores data for determining sequences of Neighbor Nodes in Data 940 in Non-Transitory, Computer Readable Storage Medium 904. Processor 902 determines sequences of Neighbor Nodes based on Sequencing Methods 1 and 2. Processor 902 uses Method 1 in conjunction with Formula 1-Scenario A Operation 932, Formula 1-Scenario B Operation 934, and Formula 2 Machine Learning Sequencing Operation 936. Processor implements User Interface (UI) 952 that is presented on Display 950. Processor 902 displays a Mapping for Collective Coverage Estimation 954 and a Sequence Output 956 on UI 952. Processor 902 determines whether to apply a first Neighbor Node sequencing method or a second Neighbor Node sequencing method. In response to Processor 902 applying the first Neighbor Node sequencing method, Neighbor Nodes are iteratively sored using a first formula until a calculated Gain in Collective Coverage is not greater than a predetermined Coverage Gain Threshold to produce a first Neighbor Node sequence, a second formula is applied to the first Neighbor Node sequence based on Machine Learning, and a second Neighbor Node sequence is generated based on the sorting the Neighbor Nodes using the second formula based on the Machine Learning. In in response to the Processor applying the second Neighbor Node sequencing method, the Neighbor Nodes are sorted using the second formula based on the Machine Learning to produce a third Neighbor Node sequence and the third Neighbor Nodes sequence is sorted using a third formula to generate a fourth Neighbor Node sequence. Processor 902 iteratively sorts Neighbor Nodes using a first formula by determining a coverage capacity of Neighbor Nodes, identifying a Neighbor Node having a maximum coverage capacity, analyzing remaining Neighbor Nodes sequenced by coverage capacity in descending order to determine a Neighbor Node from the remaining Neighbor Nodes that maximizes the Gain in Collective Coverage of Neighbor Nodes of a Source Node, determining whether the Gain in Collective Coverage is less than a Coverage Gain Threshold, in response to the Gain in Collective Coverage not being less than the Coverage Gain Threshold, returning to the analyzing the remaining Neighbor Nodes until the Gain in Collective Coverage is less that the Coverage Gain Threshold, and in response to the Gain in Collective Coverage being less than the Coverage Gain Threshold, producing the first Neighbor Node sequence. Processor 902 uses the second formula based on the Machine Learning to cluster the Neighbor Nodes into first clusters based on Coverage Compensation, to cluster Neighbor Nodes in the first clusters into second clusters based on a Handover Success Rate, and to cluster Neighbor Nodes in the second clusters into third clusters based on a Handover Attempt Count. Processor 902 clusters Neighbor Nodes in the first clusters by sequencing Neighbor Nodes in the first clusters according to Coverage Compensation, clusters the Neighbor Nodes in the second clusters by sequencing Neighbor Nodes in the second clusters according to Handover Success Rate, and clusters the Neighbor Nodes in the third clusters by sequencing the Neighbor Nodes in the third clusters according to Handover Attempt Count. Processor 902 clusters the Neighbor Nodes into the first clusters based on the Coverage Compensation using Agglomerative Hierarchical Clustering. Processor 902 sorts the third Neighbor Nodes sequence using a third formula to generate a fourth Neighbor Node sequence by calculating the Gain in Collective Coverage for a Neighbor Node in the third Neighbor Node sequence, and for Neighbor Nodes having the Gain in Collective Coverage greater than the Coverage Gain Threshold, re-sequencing the Neighbor Nodes in the third Neighbor Node sequence by the Gain in Collective Coverage in descending order to generate the fourth Neighbor Node sequence. Processor 902 iteratively sorts Neighbor Nodes using a first formula until a calculated Gain in Collective Coverage is not greater than a predetermined Coverage Gain Threshold by determining the Gain in Collective Coverage based on a Collective Coverage of Neighbor Nodes of a Source Node, wherein the Collective Coverage being an estimate from a geographic map of the ratio of the coverage area of a Source Node to a coverage area of an area of intersection of Neighbor Nodes with the Source Node.

Embodiments described herein provide a method that provides one or more advantages. For example, Neighbor Nodes compensate for a source node in response to the Source Node being offline during upgrades. Neighbors Nodes are prioritized in terms of its compensating capacity in terms of Coverage, Handover Success Rate, and Total Hand Over Attempts. A capacity-based sequence of neighbors is pre-calculated and thus is able to be used as a knowledge-base for the batch-splitting algorithm. Once a new node is added to the network, its corresponding neighbor node assessment is added to the knowledge base. A first method emphasizes Cumulative Coverage during the sequencing operation. A second method emphasizes the hierarchical features. Machine Learning is applied to sequence the Neighbor Nodes.

[1] An aspect of this description is directed to a method that includes determining to apply a first Neighbor Node sequencing method or a second Neighbor Node sequencing method, in response to determining to apply the first Neighbor Node sequencing method iteratively sorting Neighbor Nodes using a first formula until a calculated Gain in Collective Coverage is not greater than a Coverage Gain Threshold to produce a first Neighbor Node sequence, applying a second formula to the first Neighbor Node sequence based on Machine Learning, and generating a second Neighbor Node sequence based on the sorting the Neighbor Nodes using the second formula based on the Machine Learning, and in response to determining to apply the second Neighbor Node sequencing method sorting the Neighbor Nodes using the second formula based on the Machine Learning to produce a third Neighbor Node sequence, and sorting the third Neighbor Nodes sequence using a third formula to generate a fourth Neighbor Node sequence.

[2] The method described in [1], wherein the iteratively sorting the Neighbor Nodes using the first formula includes determining a coverage capacity of Neighbor Nodes, identifying a Neighbor Node having a maximum coverage capacity, analyzing remaining Neighbor Nodes sequenced by coverage capacity in descending order to determine the Neighbor Node from the remaining Neighbor Nodes that maximizes the Gain in Collective Coverage of Neighbor Nodes of a Source Node, determining whether the Gain in Collective Coverage is less than a Coverage Gain Threshold, in response to the Gain in Collective Coverage not being less than the Coverage Gain Threshold, returning to the analyzing the remaining Neighbor Nodes until the Gain in Collective Coverage is less that the Coverage Gain Threshold, and in response to the Gain in Collective Coverage being less than the Coverage Gain Threshold, producing the first Neighbor Node sequence.

[3] The method described in [1] to [2], wherein the using the second formula based on the Machine Learning, includes clustering the Neighbor Nodes into first clusters based on Coverage Compensation, clustering Neighbor Nodes in the first clusters into second clusters based on a Handover Success Rate, and clustering Neighbor Nodes in the second clusters into third clusters based on a Handover Attempt Count.

[4] The method described in [1] to [3], wherein the clustering Neighbor Nodes in the first clusters includes sequencing Neighbor Nodes in the first clusters according to Coverage Compensation, the clustering the Neighbor Nodes in the second clusters includes sequencing Neighbor Nodes in the second clusters according to Handover Success Rate, and the clustering the Neighbor Nodes in the third clusters includes sequencing the Neighbor Nodes in the third clusters according to Handover Attempt Count.

[5] The method described in [1] to [4] wherein the clustering the Neighbor Nodes into the first clusters based on the Coverage Compensation includes applying Machine Learning using Agglomerative Hierarchical Clustering.

[6] The method described in [1] to [5], wherein the sorting the third Neighbor Nodes sequence using the third formula to generate the fourth Neighbor Node sequence includes calculating the Gain in Collective Coverage for a Neighbor Node in the third Neighbor Node sequence, and for Neighbor Nodes having the Gain in Collective Coverage greater than the Coverage Gain Threshold, re-sequencing the Neighbor Nodes in the third Neighbor Node sequence by the Gain in Collective Coverage in descending order to generate the fourth Neighbor Node sequence.

[7] The method described in [1] to [6], wherein the iteratively sorting the Neighbor Nodes using the first formula until the calculated Gain in the Collective Coverage is not greater than the Coverage Gain Threshold includes determining the Gain in Collective Coverage based on the Collective Coverage of Neighbor Nodes of the Source Node, the Collective Coverage being an estimate from a geographic map of a ratio of a coverage area of a Source Node to a coverage area of an area of intersection of Neighbor Nodes with the Source Node.

[8] An aspect of this description is directed to a Neighbor Sequencer for a Smart Scheduler configured to determine to apply a first Neighbor Node sequencing method or a second Neighbor Node sequencing method, in response to determining to apply the first Neighbor Node sequencing method iteratively sort Neighbor Nodes using a first formula until a calculated Gain in Collective Coverage is not greater than a predetermined Coverage Gain Threshold to produce a first Neighbor Node sequence, apply a second formula to the first Neighbor Node sequence based on Machine Learning, and generate a second Neighbor Node sequence based on the sorting the Neighbor Nodes using the second formula based on the Machine Learning, and in response to determining to apply the second Neighbor Node sequencing method sort the Neighbor Nodes using the second formula based on the Machine Learning to produce a third Neighbor Node sequence, and sort the third Neighbor Nodes sequence using a third formula to generate a fourth Neighbor Node sequence.

[9] The Neighbor Sequencer described in [8], further configured to iteratively sort the Neighbor Nodes using the first formula by determining a coverage capacity of Neighbor Nodes identifying a Neighbor Node having a maximum coverage capacity, analyzing remaining Neighbor Nodes sequenced by coverage capacity in descending order to determine the Neighbor Node from the remaining Neighbor Nodes that maximize the Gain in Collective Coverage of Neighbor Nodes of a Source Node, determining whether the Gain in Collective Coverage is less than the Coverage Gain Threshold, in response to the Gain in Collective Coverage not being less than the Coverage Gain Threshold, returning to the analyzing the remaining Neighbor Nodes until the Gain in Collective Coverage is less that the Coverage Gain Threshold, and in response to the Gain in Collective Coverage being less than the Coverage Gain Threshold, producing the first Neighbor Node sequence.

[10] The Neighbor Sequencer described in [8] to [9], further configured to use the second formula based on the Machine Learning by clustering the Neighbor Nodes into first clusters based on Coverage Compensation, clustering Neighbor Nodes in the first clusters into second clusters based on a Handover Success Rate, and clustering Neighbor Nodes in the second clusters into third clusters based on a Handover Attempt Count.

[11] The Neighbor Sequencer described in [8] to [10], wherein the Neighbor Nodes in the first clusters are sequenced according to Coverage Compensation, the Neighbor Nodes in the second clusters are sequenced according to Handover Success Rate, and the Neighbor Nodes in the third clusters are sequenced according to Handover Attempt Count.

[12] The Neighbor Sequencer described in [8] to [11], further configured to cluster the Neighbor Nodes into the first clusters based on the Coverage Compensation by applying Machine Learning using Agglomerative Hierarchical Clustering.

[13] The Neighbor Sequencer described in [8] to [12], further configured to sort the third Neighbor Nodes sequence using the third formula to generate the fourth Neighbor Node sequence by calculating the Gain in Collective Coverage for a Neighbor Node in the third Neighbor Node sequence, and for Neighbor Nodes having the Gain in Collective Coverage greater than the Coverage Gain Threshold, re-sequencing the Neighbor Nodes in the third Neighbor Node sequence by the Gain in Collective Coverage in descending order to generate the fourth Neighbor Node sequence.

[14] The Neighbor Sequencer described in [8] to [13], wherein the Gain in Collective Coverage is based on a Collective Coverage of Neighbor Nodes of a Source Node, the Collective Coverage being an estimate from a geographic map of a ratio of a coverage area of a Source Node to a coverage area of an area of intersection of Neighbor Nodes with the Source Node.

[15] An aspect of this description is directed to a non-transitory computer-readable media having computer-readable instructions stored thereon, which when executed by a system to cause the system to perform operations including determining to apply a first Neighbor Node sequencing method or a second Neighbor Node sequencing method, in response to determining to apply the first Neighbor Node sequencing method iteratively sorting Neighbor Nodes using a first formula until a calculated Gain in Collective Coverage is not greater than a predetermined Coverage Gain Threshold to produce a first Neighbor Node sequence, applying a second formula to the first Neighbor Node sequence based on Machine Learning, and generating a second Neighbor Node sequence based on the sorting the Neighbor Nodes using the second formula based on the Machine Learning, and in response to determining to apply the second Neighbor Node sequencing method sorting the Neighbor Nodes using the second formula based on the Machine Learning to produce a third Neighbor Node sequence, and sorting the third Neighbor Nodes sequence using a third formula to generate a fourth Neighbor Node sequence.

[16] The non-transitory computer-readable media described in [15], wherein the iteratively sorting the Neighbor Nodes using the first formula includes determining a coverage capacity of Neighbor Nodes, identifying a Neighbor Node having a maximum coverage capacity, analyzing remaining Neighbor Nodes sequenced by coverage capacity in descending order to determine the Neighbor Node from the remaining Neighbor Nodes that maximize the Gain in Collective Coverage of Neighbor Nodes of a Source Node, determining whether the Gain in Collective Coverage is less than a Coverage Gain Threshold, in response to the Gain in Collective Coverage not being less than the Coverage Gain Threshold, returning to the analyzing the remaining Neighbor Nodes until the Gain in Collective Coverage is less that the Coverage Gain Threshold, and in response to the Gain in Collective Coverage being less than the Coverage Gain Threshold, producing the first Neighbor Node sequence.

[17] The non-transitory computer-readable media described in [15] to [16], wherein the using the second formula based on the Machine Learning, includes clustering the Neighbor Nodes into first clusters based on Coverage Compensation, clustering Neighbor Nodes in the first clusters into second clusters based on a Handover Success Rate, and clustering Neighbor Nodes in the second clusters into third clusters based on a Handover Attempt Count.

[18] The non-transitory computer-readable media described in [15] to [17], wherein the clustering Neighbor Nodes in the first clusters includes sequencing Neighbor Nodes in the first clusters according to Coverage Compensation, the clustering the Neighbor Nodes in the second clusters includes sequencing Neighbor Nodes in the second clusters according to Handover Success Rate, and the clustering the Neighbor Nodes in the third clusters includes sequencing the Neighbor Nodes in the third clusters according to Handover Attempt Count.

[19] The non-transitory computer-readable media described in [15] to [18] wherein the sorting the third Neighbor Nodes sequence using the third formula to generate the fourth Neighbor Node sequence includes calculating the Gain in Collective Coverage for a Neighbor Node in the third Neighbor Node sequence, and for Neighbor Nodes having the Gain in Collective Coverage greater than the Coverage Gain Threshold, re-sequencing the Neighbor Nodes in the third Neighbor Node sequence by the Gain in Collective Coverage in descending order to generate the fourth Neighbor Node sequence.

[20] The non-transitory computer-readable media described in [15] to [19], wherein the iteratively sorting the Neighbor Nodes using the first formula until the calculated Gain in Collective Coverage is not greater than the Coverage Gain Threshold includes determining the Gain in Collective Coverage based on a Collective Coverage of Neighbor Nodes of a Source Node, the Collective Coverage being an estimate from a geographic map of a ratio of a coverage area of the Source Node to a coverage area of an area of intersection of Neighbor Nodes with the Source Node.

Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method, comprising:
determining to apply a first Neighbor Node sequencing method or a second Neighbor Node sequencing method;
in response to a determination to apply the first Neighbor Node sequencing method:
iteratively sorting Neighbor Nodes using a first formula until a calculated Gain in Collective Coverage is not greater than a Coverage Gain Threshold to produce a first Neighbor Node sequence;
applying a second formula to the first Neighbor Node sequence based on Machine Learning; and
generating a second Neighbor Node sequence based on the sorting the Neighbor Nodes using the second formula based on the Machine Learning; and
in response to determining to apply the second Neighbor Node sequencing method:
sorting the Neighbor Nodes using the second formula based on the Machine Learning to produce a third Neighbor Node sequence; and
sorting the third Neighbor Nodes sequence using a third formula to generate a fourth Neighbor Node sequence.

2. The method of claim 1, wherein the iteratively sorting the Neighbor Nodes using the first formula includes:
determining a coverage capacity of Neighbor Nodes;
identifying a Neighbor Node having a maximum coverage capacity;
analyzing remaining Neighbor Nodes sequenced by coverage capacity in descending order to determine the Neighbor Node from the remaining Neighbor Nodes that maximize the Gain in Collective Coverage of Neighbor Nodes of a Source Node;
determining whether the Gain in Collective Coverage is less than the Coverage Gain Threshold;
in response to the Gain in Collective Coverage not being less than the Coverage Gain Threshold, returning to the analyzing the remaining Neighbor Nodes until the Gain in Collective Coverage is less that the Coverage Gain Threshold; and
in response to the Gain in Collective Coverage being less than the Coverage Gain Threshold, producing the first Neighbor Node sequence.

3. The method of claim 1, wherein the using the second formula based on the Machine Learning, includes:
clustering the Neighbor Nodes into first clusters based on Coverage Compensation;
clustering Neighbor Nodes in the first clusters into second clusters based on a Handover Success Rate; and
clustering Neighbor Nodes in the second clusters into third clusters based on a Handover Attempt Count.

4. The method of claim 3, wherein the clustering Neighbor Nodes in the first clusters includes sequencing Neighbor Nodes in the first clusters according to Coverage Compensation, the clustering the Neighbor Nodes in the second clusters includes sequencing Neighbor Nodes in the second clusters according to Handover Success Rate, and the clustering the Neighbor Nodes in the third clusters includes sequencing the Neighbor Nodes in the third clusters according to Handover Attempt Count.

5. The method of claim 3, wherein the clustering the Neighbor Nodes into the first clusters based on the Coverage Compensation includes applying Machine Learning using Agglomerative Hierarchical Clustering.

6. The method of claim 1, wherein the sorting the third Neighbor Nodes sequence using the third formula to generate the fourth Neighbor Node sequence includes:
calculating the Gain in Collective Coverage for a Neighbor Node in the third Neighbor Node sequence; and
for Neighbor Nodes having the Gain in Collective Coverage greater than the Coverage Gain Threshold, re-sequencing the Neighbor Nodes in the third Neighbor Node sequence by the Gain in Collective Coverage in descending order to generate the fourth Neighbor Node sequence.

7. The method of claim 1, wherein the iteratively sorting the Neighbor Nodes using the first formula until the calculated Gain in Collective Coverage is not greater than the Coverage Gain Threshold includes determining the Gain in Collective Coverage based on a Collective Coverage of Neighbor Nodes of a Source Node, the Collective Coverage being an estimate from a geographic map of a ratio of a coverage area of the Source Node to a coverage area of an area of intersection of Neighbor Nodes with the Source Node.

8. A Neighbor Sequencer for a Smart Scheduler configured to:
determine to apply a first Neighbor Node sequencing method or a second Neighbor Node sequencing method;
in response to a determination to apply the first Neighbor Node sequencing method:
iteratively sort Neighbor Nodes using a first formula until a calculated Gain in Collective Coverage is not greater than a predetermined Coverage Gain Threshold to produce a first Neighbor Node sequence;
apply a second formula to the first Neighbor Node sequence based on Machine Learning; and
generate a second Neighbor Node sequence based on the sorting the Neighbor Nodes using the second formula based on the Machine Learning; and
in response to determining to apply the second Neighbor Node sequencing method:
sort the Neighbor Nodes using the second formula based on the Machine Learning to produce a third Neighbor Node sequence; and
sort the third Neighbor Nodes sequence using a third formula to generate a fourth Neighbor Node sequence.

9. The Neighbor Sequencer of claim 8, further configured to iteratively sort the Neighbor Nodes using the first formula by:
determining a coverage capacity of Neighbor Nodes;
identifying a Neighbor Node having a maximum coverage capacity;
analyzing remaining Neighbor Nodes sequenced by coverage capacity in descending order to determine the Neighbor Node from the remaining Neighbor Nodes that maximize the Gain in Collective Coverage of Neighbor Nodes of a Source Node;
determining whether the Gain in Collective Coverage is less than the Coverage Gain Threshold;
in response to the Gain in Collective Coverage not being less than the Coverage Gain Threshold, returning to the analyzing the remaining Neighbor Nodes until the Gain in Collective Coverage is less that the Coverage Gain Threshold; and
in response to the Gain in Collective Coverage being less than the Coverage Gain Threshold, producing the first Neighbor Node sequence.

10. The Neighbor Sequencer of claim 8, further configured to use the second formula based on the Machine Learning by:
clustering the Neighbor Nodes into first clusters based on Coverage Compensation;
clustering Neighbor Nodes in the first clusters into second clusters based on a Handover Success Rate; and
clustering Neighbor Nodes in the second clusters into third clusters based on a Handover Attempt Count.

11. The Neighbor Sequencer of claim 10, wherein the Neighbor Nodes in the first clusters are sequenced according to Coverage Compensation, the Neighbor Nodes in the second clusters are sequenced according to Handover Success Rate, and the Neighbor Nodes in the third clusters are sequenced according to Handover Attempt Count.

12. The Neighbor Sequencer of claim 10, further configured to cluster the Neighbor Nodes into the first clusters based on the Coverage Compensation by applying Machine Learning using Agglomerative Hierarchical Clustering.

13. The Neighbor Sequencer of claim 8, further configured to sort the third Neighbor Nodes sequence using the third formula to generate the fourth Neighbor Node sequence by:
calculating the Gain in Collective Coverage for a Neighbor Node in the third Neighbor Node sequence; and
for Neighbor Nodes having the Gain in Collective Coverage greater than the Coverage Gain Threshold, re-sequencing the Neighbor Nodes in the third Neighbor Node sequence by the Gain in Collective Coverage in descending order to generate the fourth Neighbor Node sequence.

14. The Neighbor Sequencer of claim 8, wherein the Gain in Collective Coverage is based on a Collective Coverage of Neighbor Nodes of a Source Node, the Collective Coverage being an estimate from a geographic map of a ratio of a coverage area of the Source Node to a coverage area of an area of intersection of Neighbor Nodes with the Source Node.

15. A non-transitory computer-readable media having computer-readable instructions stored thereon, which when executed cause a system to cause the system to perform operations comprising:
determining to apply a first Neighbor Node sequencing method or a second Neighbor Node sequencing method;
in response to a determination to apply the first Neighbor Node sequencing method:
iteratively sorting Neighbor Nodes using a first formula until a calculated Gain in Collective Coverage is not greater than a predetermined Coverage Gain Threshold to produce a first Neighbor Node sequence;
applying a second formula to the first Neighbor Node sequence based on Machine Learning; and
generating a second Neighbor Node sequence based on the sorting the Neighbor Nodes using the second formula based on the Machine Learning; and
in response to determining to apply the second Neighbor Node sequencing method:
sorting the Neighbor Nodes using the second formula based on the Machine Learning to produce a third Neighbor Node sequence; and
sorting the third Neighbor Nodes sequence using a third formula to generate a fourth Neighbor Node sequence.

16. The non-transitory computer-readable media of claim 15, wherein the iteratively sorting the Neighbor Nodes using the first formula includes:
determining a coverage capacity of Neighbor Nodes;
identifying a Neighbor Node having a maximum coverage capacity;
analyzing remaining Neighbor Nodes sequenced by coverage capacity in descending order to determine the Neighbor Node from the remaining Neighbor Nodes that maximize the Gain in Collective Coverage of Neighbor Nodes of a Source Node;
determining whether the Gain in Collective Coverage is less than the Coverage Gain Threshold;
in response to the Gain in Collective Coverage not being less than the Coverage Gain Threshold, returning to the analyzing the remaining Neighbor Nodes until the Gain in Collective Coverage is less that the Coverage Gain Threshold; and
in response to the Gain in Collective Coverage being less than the Coverage Gain Threshold, producing the first Neighbor Node sequence.

17. The non-transitory computer-readable media of claim 15, wherein the using the second formula based on the Machine Learning, includes:
clustering the Neighbor Nodes into first clusters based on Coverage Compensation;
clustering Neighbor Nodes in the first clusters into second clusters based on a Handover Success Rate; and
clustering Neighbor Nodes in the second clusters into third clusters based on a Handover Attempt Count.

18. The non-transitory computer-readable media of claim 17, wherein the clustering the Neighbor Nodes in the first clusters includes sequencing Neighbor Nodes in the first clusters according to Coverage Compensation, the clustering the Neighbor Nodes in the second clusters includes sequencing Neighbor Nodes in the second clusters according to Handover Success Rate, and the clustering the Neighbor Nodes in the third clusters includes sequencing the Neighbor Nodes in the third clusters according to Handover Attempt Count.

19. The non-transitory computer-readable media of claim 15, wherein the sorting the third Neighbor Nodes sequence using the third formula to generate the fourth Neighbor Node sequence includes:
calculating the Gain in Collective Coverage for a Neighbor Node in the third Neighbor Node sequence; and
for Neighbor Nodes having the Gain in Collective Coverage greater than the Coverage Gain Threshold, re-sequencing the Neighbor Nodes in the third Neighbor Node sequence by the Gain in Collective Coverage in descending order to generate the fourth Neighbor Node sequence.

20. The non-transitory computer-readable media of claim 15, wherein the iteratively sorting the Neighbor Nodes using the first formula until the calculated Gain in Collective Coverage is not greater than the Coverage Gain Threshold includes determining the Gain in Collective Coverage based on a Collective Coverage of Neighbor Nodes of a Source Node, the Collective Coverage being an estimate from a geographic map of a ratio of a coverage area of the Source Node to a coverage area of an area of intersection of Neighbor Nodes with the Source Node.
